(19) United States
(12) Patent Application Publication
(10) Pub. No.: US 2024/0054214 A1
(43) Pub. Date: Feb. 15, 2024

(54) COMPUTERIZED SYSTEM FOR AUTONOMOUS DETECTION OF UNAUTHORIZED ACCESS ACCORDING TO OUTBOUND ADDRESSES

(71) Applicant: Virtual Connect Technologies, Inc., Greenville, SC (US)

(72) Inventors: Benjamin Hathaway, Greenville, SC (US); Theodore Wecker, Durango, CO (US); Andrew Barringer, Duncan, SC (US)

(73) Assignee: Virtual Connect Technologies, Inc., Greenville, SC (US)

(21) Appl. No.: 18/230,647

(22) Filed: Aug. 6, 2023

Related U.S. Application Data
(60) Provisional application No. 63/398,142, filed on Aug. 15, 2022.

(51) Int. Cl. G06F 21/55

(52) U.S. Cl. CPC G06F 21/554; G06F 2221/034

(57) ABSTRACT

A computerized system for autonomous detection of unauthorized access according to outbound addresses comprising: a set of computer readable instructions adapted to create a bait email, publish the bait email, monitor outbound message information, detect the bait email and take remedial action on the message server attempted to send the outbound email taken from the group of block, lock, scan, authenticate, validate, warning, and any combination thereof.

### RELATED APPLICATION

This application claims priority from U.S. Provisional Patent Application 63/398,142 filed Aug. 15, 2022, U.S. Provisional Patent Application 63/398,137 filed Aug. 15, 2022, U.S. Provisional Patent Application 63/398,132 filed Aug. 15, 2022, U.S. Provisional Patent Application 63/398,127 filed Aug. 15, 2022, and U.S. Utility patent application Ser. No. 17/883,941 filed Aug. 9, 2022, each incorporated herein by reference.

### BACKGROUND OF THE INVENTION

### 1) Field of the Invention

This system is directed to a computerized system for the detection and remediation of potential and actual unauthorized access to an electronic message system by analysis of outbound addresses and domains associated with a potential recipient.

### 2) Description of the Related Art

The use of electronic messages, especially email, is prevalent in today's society. It is estimated that billions of emails are sent per day. Email is being used for several purposes including personal communications, business communications, marketing, advertising, multi-party communications, collaboration, transmitting attachments, document or any other information interactions, and many other uses. Because of its increased use as well as the increase in security risks with modern communications, a system that can assist with the identification of security risks, analysis of weaknesses and the ability to provide recommendations would be desirable.

Some of the undesirable uses of email addresses by those such as hackers can include phishing attempts, spam, attempts to obtain financial and personal information, and other undesirable or even illegal activities. Generally, phishing refers to an attempt to gather private, confidential, or protected information by social engineering which seeks to have potential victims disclose sensitive information under false pretenses. Phishing attacks are usually carried out via communication channels such as email or instant messaging by fraudulent or misleading actors posing as legitimate and trustworthy entities so that the victim “trusts” the bad actor and discloses such information. It is desirable to identify risks that can lead to successful phishing attempts and provide preventive measures so that these attempts can be reduced if not eliminated.

The “industry” of spam, phishing, penetration, and other attacks rely upon mass emails being sent to a user in an attempt to gain access to the recipient's account. It has been reported that 3.4 billion phishing emails are sent each day worldwide and 45.37% of all emails sent in 2021 were phishing emails. Phishing attempts are one of the more severe and widespread type of cybercrime reported. The same report stated that approximately 90% of all data breaches are the result of successful phishing attempts.

Spammers and hackers use a variety of tools to obtain emails addresses so that an undesirable message can be sent to such users. The gathering of email addresses can include crawling websites looking for the “@” sign resulting in the harvest of the email. For example, if a website includes a “Contact Us” field and there is an associated link to this text to contact@company.com, the email address contact@company.com will most likely be included in an email list used by, traded, sold, and transferred to spammers and other entities. Further, hackers, including spammers, can breach a message system and use the message system for any number of undesirable actions. One such action is to access a content list and add these to a spam list. Another action is to use the breached message system for sending large amounts of electronic mailings to those on your contact list as well as to recipients unknown to the actual sender. These unauthorized emails sent from the sender message system can be used for phishing, seek sensitive information, defeat multifactor authentication, degrade online reputation, identify theft, impersonate the actual account holder and more. It would be advantageous to determine when an account or message system has been breached and implement an appropriate response when such a breach is detected or suspended.

There have been attempts to automatically filter or identify undesirable electronic messages such as shown in U.S. Pat. No. 9,501,746 which discloses a system related to detecting bad actors impersonate other people's identity in order to increase the likelihood of recipients opening those bad actors' messages and attachments. This patent states that this undesirable activity is generally referred to as “phishing” and specifically “spear phishing” when the recipient is targeted by the fake sender who is referred to as a “phisher.” This patent also states that these phishers send these “fake emails” seeking to increase their likelihood of successfully gaining unauthorized access to confidential data, trade secrets, state secrets, military information, and other information. The motivation of these phishers is typically for financial gain through fraud, identity theft and/or data theft as well as those which wish to disrupt normal operations. Phishing attempts have been associated with private entities as well as being state sponsored and even from foreign governments themselves.

One attempt to detect and/or handle targeted attacks is shown in U.S. Pat. Nos. 9,686,308 and 10,181,957 which disclose a system for detecting and/or handling target attacks in an enterprise's email channel. This patent discloses receiving aspects of an incoming electronic message addressed to a first email account holder, selecting a recipient interaction profile and/or a sender profile from a plurality of predetermined profiles stored in a memory, determining a message trust rating associated with the incoming email message based upon the incoming email message and the selected recipient interaction profile and/or the sender profile; and generating an alert identifying the incoming email message as including a security risk based upon the determined message trust rating. However, these techniques are limited to the message being received by the electronic message system and limited to the relationship between the sender and the recipient. It would be advantageous to have a system that can reduce the risks of such attacks and other security risks so that the email owner's security protection can be increased.

Another attempt to detect, prevent, and provide notification of phishing attempts is shown in U.S. Pat. No. 10,404,745 which discloses the use of natural language techniques and information present in an email (namely the header, links, and text in the body) to detect phishing. This system is limited to an analysis of the email itself and occurs once the phishing attempt or attack has been initiated. It would be advantageous to reduce the ability of a phishing attempt to occur in the first place, rather than an “after-the-fact” solution as in the prior art.

One attempt to prevent online fraud is shown in U.S. Pat. No. 10,628,797 that states that the system can receive and categorize incoming email messages and attempts to determine that the incoming email is being used to attempt an unauthorized access to data, accounts, information, and the like. However, this system focuses on the incoming email message and cannot determine if the target message system has been breached.

Historically, attempts to prevent breaches are just that, preventive and have not been focused on detecting breaches or other unauthorized access. Such attempts have focused on incoming attempts and devices. U.S. Pat. No. 9,916,481 states that it is systems and methods for detecting the loss, theft, or unauthorized use of a device and/or altering the functionality of the device in response. The system described in this reference reacts to a detection that a security compromise event has occurred for a mobile device, not an electronic message system, local or enterprise wide.

As shown above, email protection strategies are not as simple as subscribing to a spam filter and require a layered approach, which reduces risks. Generally, the more layers, the greater the reduction in risk. Layers include the systems, techniques, frameworks, and other methods discussed above. Further, changes in the email system can result in one or more of the installed schemes being changes, outdated, improperly configured or otherwise less than optimal. Understanding what is installed, configured, and properly operating would be beneficial for the reduction in the risks associated with email communications.

Therefore, it is an object of the system to provide for a system that can determine if the recipient is attempting to send an electronic message to a detection email address potentially indicating that an unauthorized access has occurred.

It is another object of the system to provide a response to actual or potential unauthorized access of an electronic system.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a schematic of aspects of the system.

FIG. 2 is a schematic of aspects of the system.

FIG. 3 is a flowchart of aspects of the system.

FIG. 4 is a schematic of aspects of the system.

FIG. 5 is a schematic of aspects of the system.

FIG. 6 is a schematic of aspects of the system.

FIG. 7 is a flowchart of aspects of the system.

### DETAILED DESCRIPTION OF THE INVENTION

With reference to the drawings, the invention will now be described in more detail.

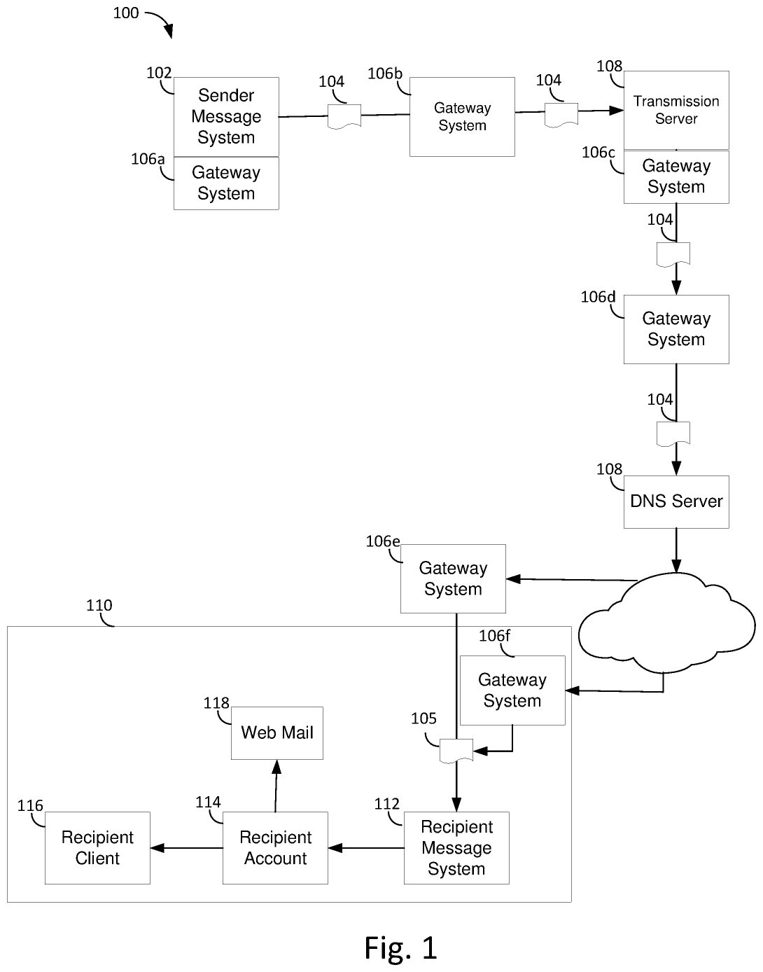

Referring to FIG. 1, and using an email system as an example, an analysis system is shown generally as 100. The sender message system 102 is used to send electronic message 104 to one or more recipients and the sender typically can access the system directly or through SaaS (e.g., cloud based). The gateway system can be included as an application data interface to the message system as shown in 106a, in a communication with the message system as shown as 106b, as an application programming interface to a transmission server as shown in 106c or in communication with the transmission server at shown in 106d. The gateway system can include hardware and software in each of these positions or a combination of these positions. The gateway system 106e can also be located outside of the recipient's domain or can be included in the recipient domain as shown as 106f. The gateway server can receive incoming messages at one of these positions or a combination of these positions. The gateway server can be a separate system that is in communications with one or more components of the sender's domain and the recipient's domain or can be integrated into one of the components of the sender domain and the recipient domain. The gateway server can receive an incoming message (e.g., transmitted message) prior to, during or after the message is on a wide area network.

The gateway system can analyze or receive one or more outbound electronic messages 104. In any case, the gateway system can retrieve from the header, or other information, the intended recipient of the outbound electronic message. The electronic message system can then determine the recipient location or path associated with delivery of the message using a DNS server 108. If delivery is permitted, the electronic message can be sent to the recipient domain 110 and on to the recipient message system 112. In one embodiment, the outbound electronic message 104 can be modified by the gateway system or an application programming interface along the travel path so that an altered message is transmitted to the recipient message system 112. The altered message can be delivered to the recipient account 114 and accessed by the recipient client 116 or other access such as webmail 118.

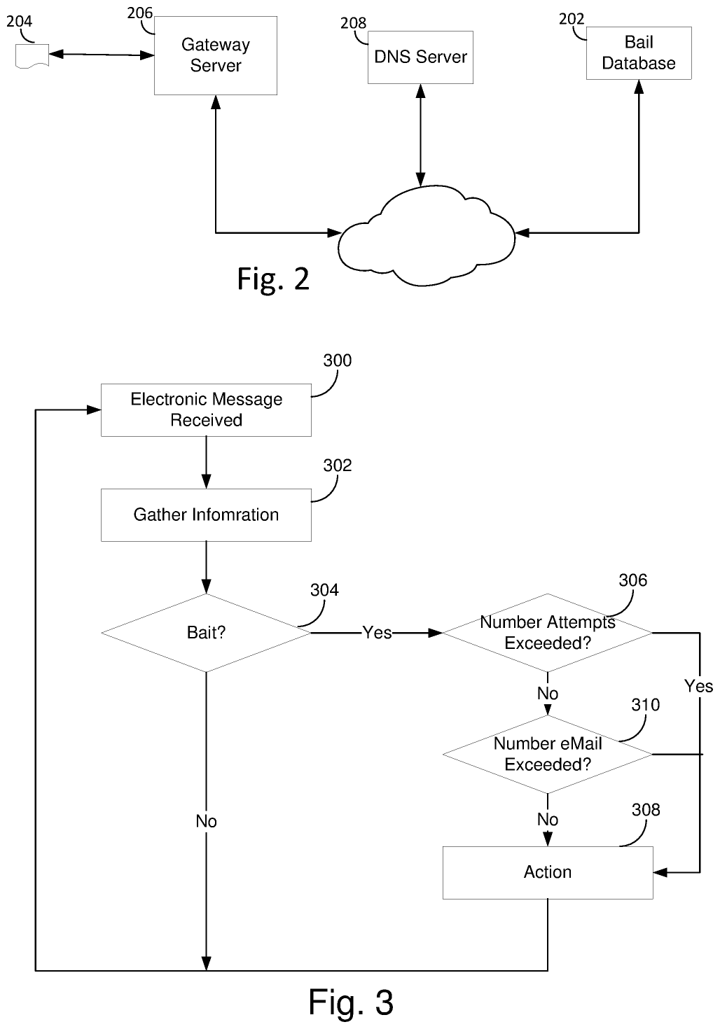

Referring to FIG. 2, the outbound electronic message 204 is analyzed by gateway system 206 which can review the header information of the message and retrieve the intended recipient. For example, following is an example of a recipient retrieved from the header of an electronic message:

| | |
|---|---|
| To: Name <user@domain.com> | (1) |

The gateway system can determine the domain of the intended recipient and determine if this is a valid email or not according to several methods. In one embodiment, the gateway system can seek to retrieve the MX record associated with the “domain.com,” such as with computer readable instructions combined with a computer system. It results in a message system domain name verification computer by implementing the following commands, in one example:

| | |
|---|---|
| nslookup | |
| | (2) |
| set type=MX | |
| domain.com | |

If the response to gateway system includes an IP address, the gateway system can determine that the domain is in existence by attempting to receive information from a system such as DNS server 208. If the response represents that the domain name is not in existence, then the gateway system can determine that the sender message server is attempting to send an email to a non-existent recipient and that the sender message system may be subject to an unauthorized access. The gateway system may also determine that the domain is invalid as being geographically disallowed. The gateway system can also have a threshold that if a predetermined number of recipient domains are non-existent or invalid, that the sender message server can be subject to unauthorized access.

In one embodiment, the gateway system can determine that the email address has a valid domain, but the recipient (e.g., username) is invalid. In this case, the message can be delivered to the intended recipient message system and the recipient message system can indicate that the username is not valid or that the user account does not exist. The gateway system can calculate and track the number of undeliverable responses received from the intended recipient's message system. An error message can include one or more of the following, according to configuration of the recipient message system:

| | |
|---|---|
| Address not found | (3) |
| Mailbox not found | (4) |
| Invalid mailbox | (5) |
| User unknown | (6) |
| Mailbox unavailable | (7) |
| Undeliverable | (8) |

The gateway system can create bait user accounts that have bait email addresses and publish these to one or more websites. For example, the gateway system can access a website and modify an email address periodically to include a bait email address. For example, the gateway system can auto generate email address such as bait-A@domain.com. This generated email address has certain properties that can include that it has not been previously used. The generated email address may not match the pattern of email addresses that are used for the sender message system. For example, if usernames are first initial and last name, the example generated email address does not match this pattern. The generated email access could be a generic username such as info@, help@, support@, contact@, and the like. Typically, spammers and hackers are attracted to these accounts. The generated email may include a subdomain such as @company.bait.com. The gateway system can generate these email addresses or can receive these from an outside source. In one embodiment, the gateway system can access databases of other sources of bait email such as other spam or “honey pot” system that have identified certain email addresses as bait emails.

Once generated or received, in one embodiment, the gateway system can publish the email address in a number of ways. In one embodiment, the gateway system can access the website under the domain company.com and add the generated address to the website. When a spammer or hacker is scraping the email address, the generated email address will likely be found and added to a distribution list of the spammer or hacker. For example, the website can include the following HTML code:

| | |
|---|---|
| <div style=“display: none;”> | |
| Contact our <a href=“bait-A@company.com”> Fraud | |
| | (9) |
| Department </a> if you are <a href=“bait-B@company.com”> | |
| attempting to </a> to breach our message system. | |
| </div> | |

In one embodiment, the generated email can be placed on the website with the same font, foreground, background, and highlighted color so that a spammer or hacker would find the generated email, but the email is not visible to a human user. The gateway system can also update a separate webpage, such as one associated with the sub domain, indexing is disabled to further conceal the generated email address.

In one embodiment, the gateway system can access an existing listing of bait email addresses though a third-party database. The gateway system can either provide the third-party database with the generated email or use an email that is generated by the third party.

When the gateway system determines that the sender account is being used to send a generated email or other bait email, it can indicate that the sender account has been subject to unauthorized access. In this case, the gateway system can take any number of actions including the following:
Generate a warning that can be transmitted to the electronic message system, administrator, recipient, third party (e.g., blacklist), reputation administrator, or other third party.
Lock the account of the sender.
Quarantine outbound electronic messages.
Delete one or more outbound messages.
Modify the header of the message indicating that the email is or may be from a compromised account.
Require a password reset for the sender's account.
Require multifactor authentication for the sender's account.
Initiate a scan of the electronic message system of the user's account.
Require a change in security questions.
Verify security or privacy settings.
And any combination of the above.

Referring to FIG. 3, the gateway system can receive or review an electronic message attempted to be sent to a recipient at 300. The electronic message is an outbound message from the message server. The gateway system can then gather information associated with the outbound message at 302 and can determine information such as the recipient username, recipient domain recipient MX record, recipient IP address, and the like. The gateway system can determine if the recipient email address is a bait email address at 304. If the intended recipient is a known bait email address, the gateway system can determine if the number of attempts by the sender message system to send an email to the bait address exceeds a predetermined number at 306 and if so, take action at 308. The gateway system can also determine both the number of outbound electronic messages sent by the sender message system and can determine whether the number of attempts by the sender message system to send and email to the bat address exceeds a predetermined percentage of total outbound messages sent by the sender message system. In one embodiment the predetermined percentage is 2% or greater. One method of determining the number of attempts is to by receiving an undeliverable response from the recipient's message system. The gateway system can also determine at 310 if multiple bait emails have been included as intended recipients and if so, take action at 310.

During the process of analyzing the email that the sender message system has attempted to send, the gateway system can analyze components of header seeking information about the recipient.

| | |
|---|---|
| Received: from CY4PR2201MB1384.namprd22.prod.outlook.com | (10) |
| (2603:10b6:910:6a :: 22) by SN4PR22MB2902.namprd22.prod.outlook.com | |
| with HTTPS; Tue, 28 Jun 2022 14:55:33 +0000 | |
| Received: from MW2NAM04FT012.eop- | (11) |
| NAM04.prod.protection.outlook.com (2603:10b6:303:2a:cafe :: 2) by | |
| MW3PR06CA0018.outlook.office365.com (2603:10b6:303:2a :: 23) with | |
| Microsoft SMTP Server (version=TLS1_2, | |
| cipher=TLS_ECDHE_RSA_WITH_AES_256_GCM_SHA384) id | |
| 15.20.5373.16 via Frontend Transport; Tue, 28 Jun 2022 14:55:31 +0000> | |
| Received: from otransport-12.outbound.emailsrv.net (52.1.62.31) by | (12) |
| MW2NAM04FT012.mail.protection.outlook.com (10.13.31.127) with | |
| Microsoft SMTP Server (version=TLS1_2, | |
| cipher=TLS_ECDHE_RSA_WITH_AES_256_GCM_SHA384) id | |
| 15.20.5373.15 via Frontend Transport; Tue, 28 Jun 2022 14:55:31 +0000 | |
| Received: from NAM10-MW2-obe.outbound.protection.outlook.com (mail- | (13) |
| mw2nam10lp2106.outbound.protection.outlook.com [104.47.55.106]) by | |
| ogate-3.outbound.emailservice.io (Postfix) with ESMTPS id D2D80A966C | |
| for <doug@kimandlahey.com>; Tue, 28 Jun 2022 14:55:29 +0000 (UTC) | |
| DKIM-Signature: v=1; a=rsa-sha256; c=relaxed/relaxed; | (14) |
| d=Mailprotector.onmicrosoft.com; s=selector2-Mailprotector-onmicrosoft- | |
| com; | |
| h=From:Date:Subject:Message-ID:Content-Type:MIME-Version:X-MS- | |
| Exchange-SenderADCheck; | |
| bh=CN+f5XFwlaGaTKhNrulNut5x70E5mnx3t4xVI+4qvkQ =; | |
| Received: from DM4PR19MB5761.namprd19.prod.outlook.com | (15) |
| (2603:10b6:8:60 :: 17) by BNOPR19MB5278.namprd19.prod.outlook.com | |
| (2603:10b6:408:151 :: 17) with Microsoft SMTP Server (version=TLS1_2, | |
| cipher=TLS_ECDHE_RSA_WITH_AES_256_GCM_SHA384) id | |
| 15.20.5373.18; Tue, 28 Jun 2022 14:55:26 +0000 | |
| Received: from DM4PR19MB5761.namprd19.prod.outlook.com | (16) |
| ([fe80 :: d447:8c8:3b5c:1119]) by | |
| DM4PR19MB5761.namprd19.prod.outlook.com | |
| ([fe80 :: d447:8c8:3b5c:1119%9]) with mapi id 15.20.5373.018; Tue, 28 Jun | |
| 2022 14:55:26 +0000 | |
| From: SenderName <sender.name@companynone.com> | (17) |
| To: RecipientName <recipient@companytwo.com> | |
| Subject: Intellectual Property | |
| Thread-Topic: Intellectual Property | |
| Thread-Index: | |
| AQHYiiN1/x19gZsj6EuDAE8S5xw5nq1k0sUAgAAKU4CAAAbpgIAABesA | |
| Date: Tue, 28 Jun 2022 14:55:26 +0000 | |
| Message-ID: < 4397EC37-3901-4122-AE57- | |
| 28305CF8B2F7@compayone.com> | |
| In-Reply-To: | |
| <SN4PR22MB2902782099AD395EA9F4382ED1B89@SN4PR22MB2902 | (18) |
| .namprd22.prod.outlook.com> | |
| Accept-Language: en-US | |
| Content-Language: en-US | |
| X-MS-Has-Attach: | |
| X-MS-TNEF-Correlator: | |
| Authentication-Results-Original: | |
| dkim=none (message not signed) | |
| header.d=none; | |
| dmarc=none action=none | |
| header.from=companyone.com; | |
| spf=none; | |
| X-Microsoft-Antispam-Message-Info-Original: | |
| zzKZNSEnd7Z8oihwEWwkiQF6Pvi6TIllobQXfo7PWxoDRY9M29iCAY3Yr | (19) |
| P9cnFYiGy0Uf0DB7HPRnb0pAMo8KEIVS7yw1YNCJY9KfDuMkpcD5u8T | |
| z/gvvN+fXS/liXZZFGMQQ9w/GCm4PZBsEQJ7vF2h7wWaMVWdK9BzkW | |
| 5uJMxBqFyRsKeHMDOJmq+HdCAfUcQH0qJegXbkoXBFiVqICIL787luOh | |
| 6LGcx3N28FaW/WycZlpTKTq54CQjUU99JaMPpdVWfxh7Qz4Zv35CQ3P | |
| qwgODUGasTYdM9BYxULY1aPyYBtvTKyrkJqOrX/6EIEAndqS5MvDKDP | |
| 5xBT26zl3vy+E+s87XLW5/VZNUilgclqLKQAOYuDYPugHVZG4ENwy97it | |
| 1eEb4Jblz4eu0HXtCRtl9uv40mr3/m/YV8iexZtnP21bNUG85n82JVrbBwz7 | |
| W6kS/g3FVzOSIrFncs1ARF8trPLOiLxIBUQ4NNzSWohQhwRg8cm2fPOrz | |
| iSv581/TtA3NWdJ+trW8BDJjfuHDzWY/bL4vmZhU9h7uNw7fAsmW+sdtniE | |
| yaKeenYPrOdwBShlbfqQ42vHNag+EH/xLjUCBDcZjUlCeLelitPBHffoDtca | |
| GtIVBE2zqkXWvYBJ5tXUrpZ3vG7PdE8ejtv41yNku1Oc2NrvZIFt2J2/w5Ub | |
| t80msrQ4VB1X1IPrYFAGjZW8incjFwCXEMjg40C5+UioHpWhk+dq9/v0B | |
| MgSZhdmknhcVAGW4fxLkd2/ufjMYsc07/P+B9qrmT6fuNIv2mkL4KROvs0 | |
| IQwAoq38dyvbmreofMFbrwVizdWArpDGaNnrxqlpllhcLSzpOxA4Qiin/AT/r | |
| wjFGI+y1t9XIMe68iAAqORjrw9zbMG03+PBWJ9fFwZdNpZeWeeB+73uH | |
| dRA8hm1uhiezKsM4PVOUsU= | |

From an analysis of the information for this email header, it can be seen that the intended recipient is recipient@companytwo.com.

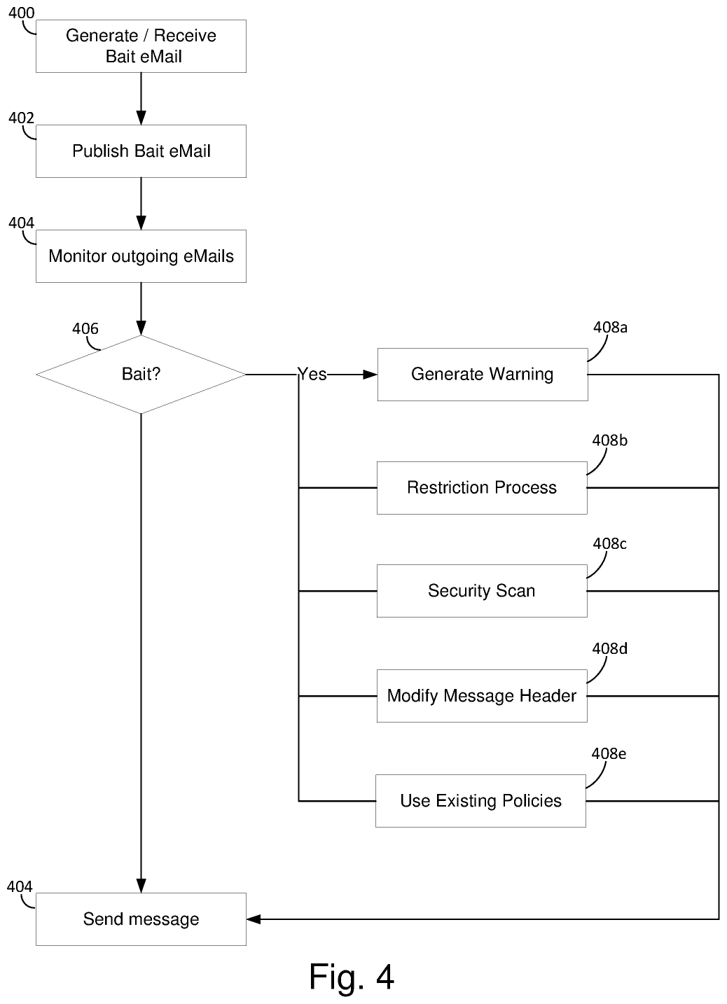

Referring to FIG. 4, the gateway system can generate or receive one or more bait email address(es) at 400. The bait email can be developed manually from the administration or other use of the sender message system, it can be autogenerated from the gateway system, it can be accepted or rejected by a user of the gateway system or sender message system, and any combination. A bait email address can be published at 402. The gateway system can then monitor all outgoing emails at 404. If the gateway system determines at 406 that a recipient email address is a match to a bait email address, the gateway system can take action including generating a warning at 408a. This warning can be transmitted to the sender message system recipient, sender alternative email address, physically transmitted, transmitted to a third party such as a blacklist database, hosting company, and the like, or any combination. The gateway system can implement a restriction process at 408b that can include locking one or more accounts, quarantining outbound messages, blocking outbound messages, activating two factor authentication, activating verification of the account holder, require changes to one or more passwords, and any combination at the user level to the enterprise level. The gateway system can also initiate security scans at 408c. The gateway system can also modify the message with an indication that the email message may be spam so that the recipient message system can use the information and take the appropriate action. The actions that are taken can also be according to policies that the sender message server has established for inbound messages as shown at 408e. For example, if the existing policies for inbound messages state that spam is to be placed on a spam folder, the gateway system or application programming interface to the sender message system can place the outbound message in a spam folder. The spam folder can be designed at outbound in one embodiment so that if the sender message system is discovered not to be compromised, the outbound messages can be subsequently sent without the need to recreate the message.

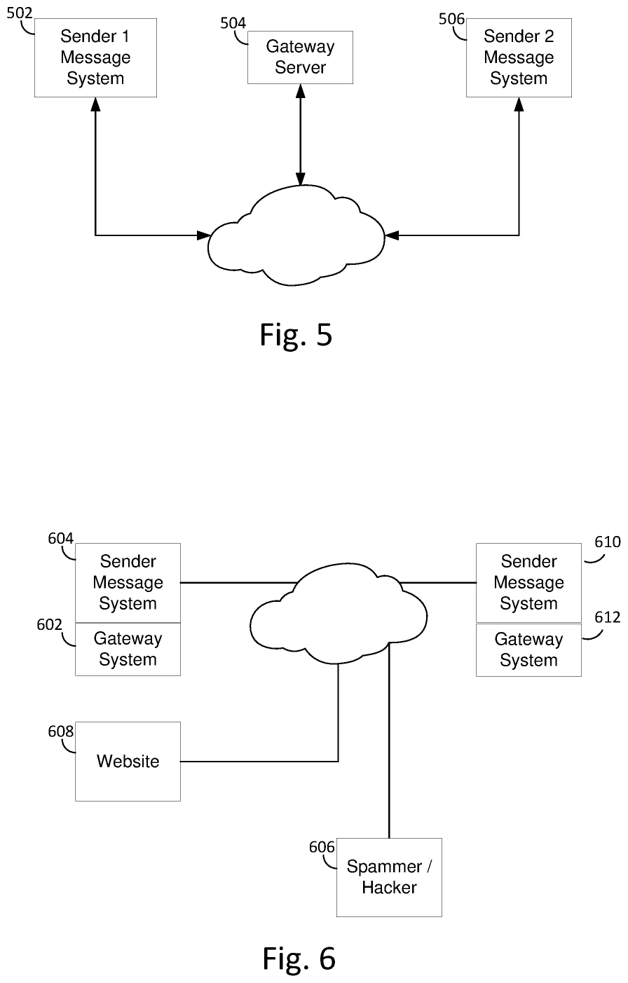

The gateway system can also be connected to multiple message systems and multiple domains. Referring to FIG. 5, the gateway system can be in communications with sender 1, message system 502. In this example, the sender 1 message system can include a bait email address in its contacts or on its website. The spammer or hacker can discover this bait message address and include it in a spam or other transmission. The spammer or hacker can have compromised the sender 2 message system and may attempt to send a message to the bait message address from sender 2 message system. The gateway system can determine that the bait message address is associated with the server 1 message system, but that the sender 2 message system 506 attempted to send messages to the bait message. Therefore, the gateway system can determine that the server 2 message system may have been compromised and take appropriate action.

Referring to FIG. 6, a first gateway system 602 can be associated with a first sender message system 604. The first gateway system can generate or have a bait email associated with the first sender message system that can be published, such as on a website 608. The bait email address can be known to a second gateway system 612. Once published, the spammer or hacker 606 can discover the bait email address and the bait email address could appear during a spam, phishing, or other undesirable action or campaign by a spammer or hacker. In the event that the spammer or hacker successfully breaches a second sender message system 610, the spammer or hacker could attempt to send undesirable emails to the bait email from the second sender message system. The second gateway system 612 can detect the bait email as an intended recipient and take action as discussed herein.

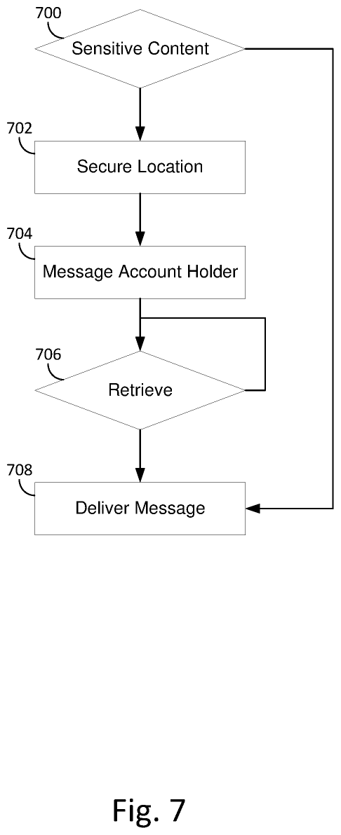

Referring to FIG. 7, in one embodiment, the gateway system can detect sensitive information in the content of a message or attachment at 700 and place the email message in a secure location 702 if the message includes sensitive content. Otherwise, the messages can be transmitted to the account holder inbox. The determination of the sensitive content or attachment can be made prior to the message arriving at the inbox or when the message is in the inbox. In the case where the sensitive content or attachment is detected in the inbox, the message can be moved to the secure location and removed from the inbox. The secure location can be a remote storage location from that of the account holder message system. For example, the message or attachment can be transmitted encrypted to a remote database and stored encrypted outside the account holder message system. Therefore, the sensitive content or attachment is out of the normal travel path of electronic communications for that account holder.

The determination of sensitive content or attachment can be determined by the content itself, information in a subject line, keywords, message header information, file names, file types, attachment types, and any number of methods.

When the message or attachment is sent out of band to the remote storage locations, a storage message can be sent to the account holder at 704 that can arrive in the inbox alerting the account holder that sensitive content or attachment was intended for the account holder but was placed on remote secure storage and not delivered to the inbox. The account holder can then take action to retrieve the message or content at 706. If the account holder wishes to retrieve the message or attachment, the account holder can send a reply message, access a third-party site, sent an original message, provide validation, provide multifactor authentication, and others and any number of combinations of these methods. The message can be delivered to the account holder at 708. The remote storage location can have perimeters concerning the storage sensitive messages, content and attachments that can include additional identification for retrieval, autodeletion upon failed attempts, autodeletion upon some period of time and any combination.

The system described herein is directed to a series of acts that can protect a computer or computer system from electronic communication that may contain malicious code of other undesirable content. The computerized system is one that is at least directed to a process. The system can identify and potentially isolate electronic messages in an electronic message system according to the edge value and/or the confidence values. The edge value and confidence values associated with a sender or electronic message can be stored in a database that can be accessible by a second analytical computer system that does not have to be in direct communications with the first analytical computer system. The processes and procedures that are described herein can be actuated by a computer processor that executes computer readable instructions to provide the functionality herein.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A computerized system for detection of unauthorized access comprising:
a sender message system adapted to create and transmit an outbound electronic message;
a gateway system in communications with the sender message system wherein the gateway system is adapted to:
determine a number of outbound electronic messages sent by the sender message system;
receive an undeliverable response from a recipient message system associated with the outbound electronic message;
increase an undeliverable counter by one;
determine an undeliverable percentage according to the undeliverable counter and the number of outbound electronic messages sent;
calculate a historical undeliverable response value;
generate a potential breach warning according to the undeliverable counter exceeding a predetermined count limit, the undeliverable percentage exceeding a predetermined percentage limit, the undeliverable counter exceeding the historical undeliverable response value, the outbound electronic message is addressed to a bait address, an IP address associated with the outbound electronic message being invalid and any combination thereof; and,
transmitting the potential breach warning to a user.

2. The system of claim 1 wherein the gateway system is adapted to generate the bait address.

3. The system of claim 2 wherein the outbound electronic message is a first outbound electronic message, and the gateway system is a first gateway system adapted to transmit the bait address to a second gateway system wherein the second gateway system is adapted to generate a second gateway system potential breach warning according to a second outbound electronic message being addressed to the bait address.

4. The system of claim 3 wherein the first gateway system is associated with a first sender domain and the second gateway system is associated with a second sender domain.

5. The system of claim 1 wherein the gateway system is adapted to modify a website associated with a sender domain to add the bait address to the website.

6. The system of claim 1 wherein the gateway system is adapted to assign criteria to the bait address including that the bait address has not been used prior to its publication.

7. The system of claim 1 wherein the bait address includes a subdomain.

8. The system of claim 1 wherein the gateway system is adapted to transmit the bait address to a third party email listing.

9. The system of claim 1 wherein the user is taken from the group consisting of administrator, sender, recipient, third party, reputation administrator, and any combination.

10. The system of claim 1 wherein the gateway system is adapted to modify the outbound electronic message to add a potential spam indicator according to the undeliverable counter exceeding a predetermined count limit, the undeliverable percentage exceeding a predetermined percentage limit, the undeliverable counter exceeding the historical undeliverable response value, the outbound electronic message is addressed to a bait address, and any combination thereof.

11. The system of claim 1 wherein the gateway system is adapted to take action from the group consisting of locking a sender account associated with the outbound electronic message, placing the outbound electronic message in quarantine, deleting the outbound electronic message, requiring a password reset for the sender account, requiring multifactor authentication for the sender account, scanning the sender message system, requiring a change in security question for the sender account, verifying security and privacy settings of the sender account and any combination thereof according to the undeliverable counter exceeding a predetermined count limit, the undeliverable percentage exceeding a predetermined percentage limit, the undeliverable counter exceeding the historical undeliverable response value, the outbound electronic message is addressed to a bait address, and any combination thereof.

12. The system of claim 1 wherein the undeliverable response is an invalid domain.

13. The system of claim 1 wherein the undeliverable response is an invalid address.

14. The system of claim 1 wherein the predetermined percentage limit is two percent or greater.

15. The system of claim 1 wherein the gateway system is in communications with the sender message system using an application programming interface.

16. A computerized system for detection of unauthorized access comprising:
a sender message system adapted to create and transmit an outbound electronic message;
a gateway system adapted to intercept an outbound electronic message transmitted from a sender message system wherein the gateway system is adapted to:
receive an undeliverable response from a recipient message system associated with the outbound electronic message;
generate a potential breach warning according to an undeliverable counter exceeding a predetermined count limit, an undeliverable percentage exceeding a predetermined percentage limit, an undeliverable counter exceeding a historical undeliverable response value, the outbound electronic message being addressed to a bait address, an IP address associated with the outbound electronic message being invalid and any combination thereof; and,
according the potential breach warning, taking action from the group consisting of sending a warning to a user, locking a sender account associated with the outbound electronic message, placing the outbound electronic message in quarantine, deleting the outbound electronic message, requiring a password reset for the sender account, requiring multifactor authentication for the sender account, scanning the sender message system, requiring a change in security question for the sender account, verifying security and privacy settings of the sender account and any combination thereof according to the undeliverable counter exceeding a predetermined count limit, the undeliverable percentage exceeding a predetermined percentage limit, the undeliverable counter exceeding the historical undeliverable response value, the outbound electronic message being addressed to a bait address, and any combination thereof.

17. The system of claim 15 wherein the user is taken from the group consisting of administrator, sender, recipient, third party, reputation administrator, and any combination.

18. The system of claim 15 wherein the IP address associated with the outbound electronic message is invalid due to its origin being geographically disallowed.

19. A computerized system for detection of unauthorized access comprising:
a gateway system adapted to intercept an outbound electronic message transmitted from a sender message system wherein the gateway system is adapted to:
receive an undeliverable response from a recipient message system associated with the outbound electronic message;
generate a potential breach warning according to an undeliverable counter exceeding a predetermined count limit, an undeliverable percentage exceeding a predetermined percentage limit, an undeliverable counter exceeding a historical undeliverable response value, the outbound electronic message being addressed to a bait address, an IP address associated with the outbound electronic message being invalid and any combination thereof.

20. The system of claim 18 where in the gateway system is adapted to take action from the group consisting of sending a warning to a user, locking a sender account associated with the outbound electronic message, placing the outbound electronic message in quarantine, deleting the outbound electronic message, requiring a password reset for the sender account, requiring multifactor authentication for the sender account, scanning the sender message system, requiring a change in security question for the sender account, verifying security and privacy settings of the sender account and any combination thereof according to the undeliverable counter exceeding a predetermined count limit, the undeliverable percentage exceeding a predetermined percentage limit, the undeliverable counter exceeding the historical undeliverable response value, the outbound electronic message being addressed to a bait address, and any combination thereof according to the potential breach warning.

21. The system of claim 19 wherein the gateway system is adapted to release the outbound electronic message from quarantine upon request from a user.
